(19) United States
(12) Patent Application Publication
(10) Pub. No.: US 2013/0088854 A1
(43) Pub. Date: Apr. 11, 2013

(54) Led Lamp

(71) Applicant: Ho-Hsin Chiu, Hsinchu (TW)

(72) Inventor: Ho-Hsin Chiu, Hsinchu (TW)

(21) Appl. No.: 13/267,903

(22) Filed: Oct. 7, 2011

(51) Int. Cl. F21V 33/00

(52) U.S. Cl. 362/95

(57) ABSTRACT

An LED lamp includes a hollow socket including a lower receptacle, a projection on an inner surface of an upper portion, and a protrusion extending outward; a hollow holder including an annular flange on one end, bottom first and second cuts on the other end, a bendable holed handle extending outward, and a groove on an outer surface snugly put on the projection wherein the holder is seated on the socket by bending the handle downward to lockingly put on the protrusion; two opposite electrical contacts fastened on walls of the receptacle; two conductive wires each having one end secured to the electrical contact and the other extending out of the receptacle; an LED seated in the flange wherein both first and second contact wires of the LED are inserted through the channel to have their ends bent to contact the electrical contacts respectively; and a bulb.

### BACKGROUND OF THE INVENTION

1. Field of the Invention

The invention relates to lighting devices and more particularly to an improved LED (light-emitting diode) lamp which can be part of a light string for decorative or ornamental lighting (e.g., Christmas lighting) or used as a single light source.

2. Description of Related Art

A conventional LED lamp is shown in FIG. 1. The LED lamp may be part of a light string for decorative lighting (e.g., Christmas lighting) or used as a single light source. The LED lamp comprises a holder 20 having a projection 211 extending downward to be securely inserted into a socket (not numbered).

However, the LED lamp suffers from a number of drawbacks. For example, the projection 211 can adversely increase the total length of the LED lamp. More precision is required in its assembly. This can increase the manufacturing cost greatly. Further, it is not visually attractive. Thus, the need for improvement still exists.

### SUMMARY OF THE INVENTION

It is therefore one object of the invention to provide an LED light source comprising a hollow socket comprising a lower receptacle, a projection formed on an inner surface of an upper portion of the socket, and a protrusion extending outward from an upper portion of the socket; a hollow holder comprising an axial channel, an annular flange on one end of the channel, a bottom first cut on the other end of the channel distal the flange, a bottom second cut on the other end of the channel opposite the first cut, a bendable holed handle extending outward from an upper portion of the holder, and a groove formed on an outer surface of the holder, the groove being complimentary to the projection wherein a lower portion of the holder is disposed in upper and intermediate portions of the receptacle and spaced from walls of the receptacle, the groove is snugly put on the projection, and the upper portion of the holder is securely seated on the socket by bending the handle downward about 90-degree to lockingly put on the protrusion; two opposite electrical contacts fastened on walls of the receptacle and spaced from the holder; two conductive wires each having one end secured to the electrical contact and the other extending out of the receptacle; an LED seated in the flange and comprising a first contact wire and a second contact wire, the second contact wire being shorter than the first contact wire wherein both the first and second contact wires are inserted through the flange and the channel to have their ends bent to pass through both the first and second cuts to contact the electrical contacts respectively; and a bulb fastened on the holder to enclose the LED.

The above and other objects, features and advantages of the invention will become apparent from the following detailed description taken with the accompanying drawings.

### BRIEF DESCRIPTION OF THE DRAWINGS

FIG. 1 is a longitudinal sectional view of a conventional LED lamp;

FIG. 2 is an exploded view of an LED lamp according to the invention with a glass bulb removed;

FIG. 3 is a longitudinal sectional view of the holder of FIG. 2;

FIGS. 4 and 5 are left and right side views of the holder of FIG. 2 respectively;

FIGS. 6 and 7 are left and right side views of a second configuration of holder of the LED lamp according to the invention respectively, the second configuration of the holder having first and second cuts being different from that shown in FIGS. 4 and 5;

FIG. 8 is another exploded view of the LED lamp shown in FIG. 2; and

FIG. 9 is a longitudinal sectional view of the LED lamp being fully assembled.

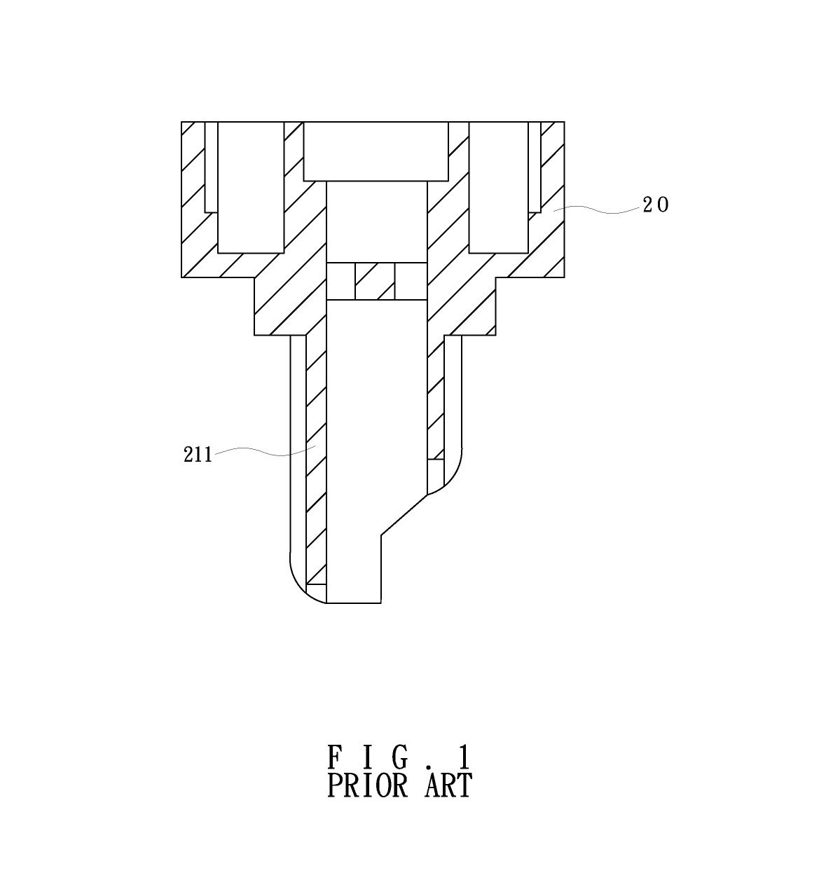

### DETAILED DESCRIPTION OF THE INVENTION

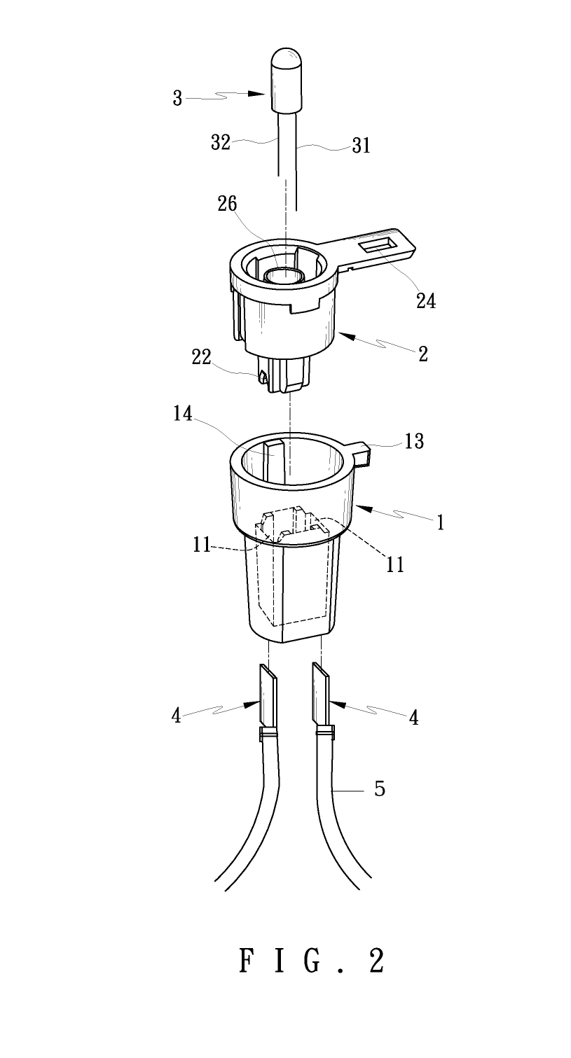

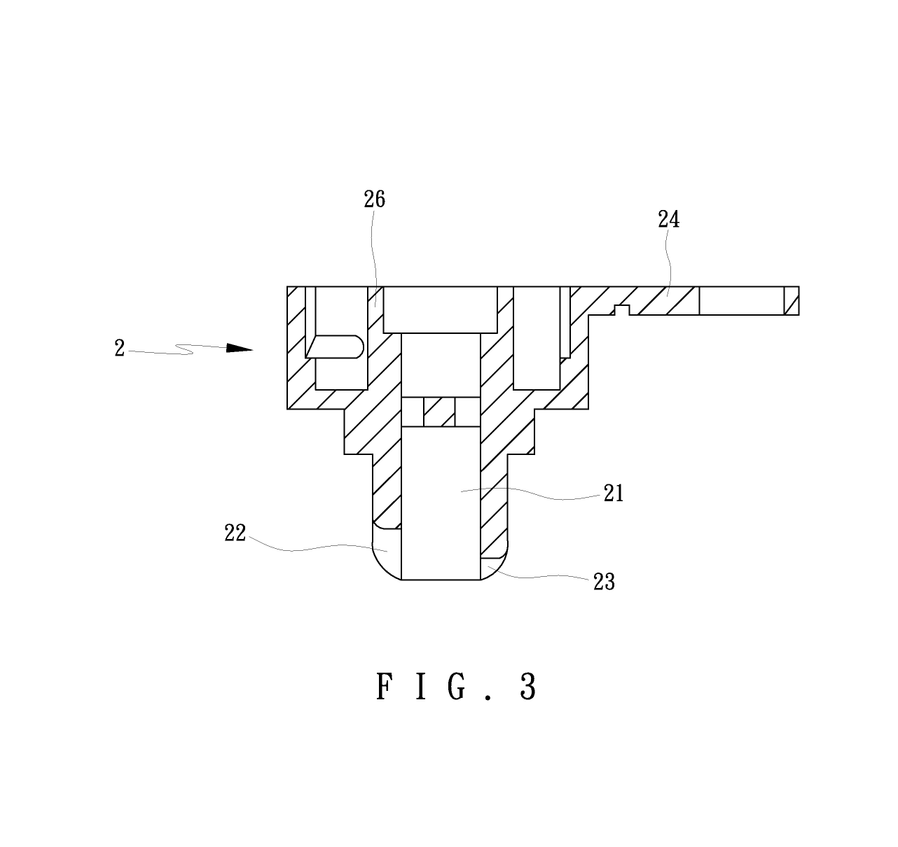

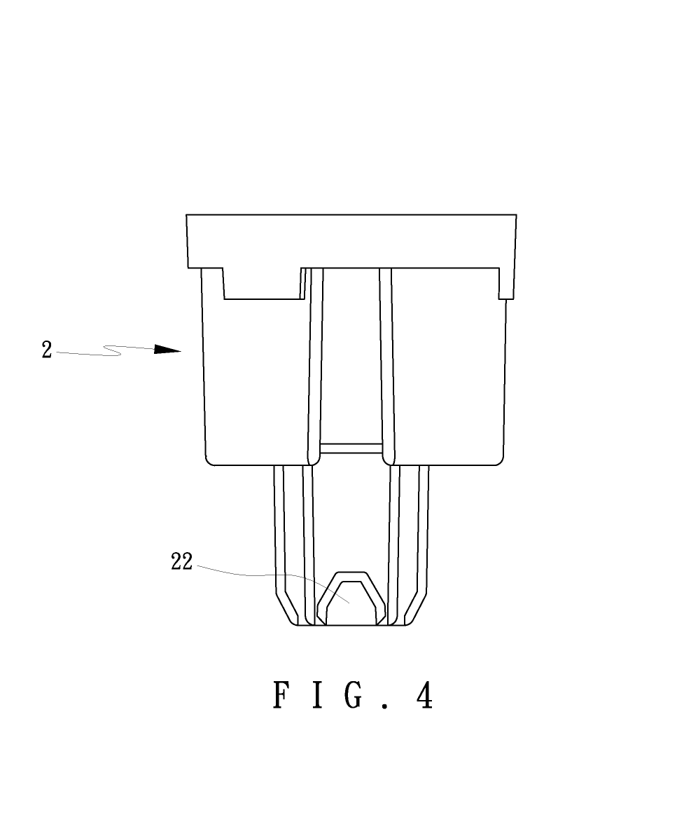

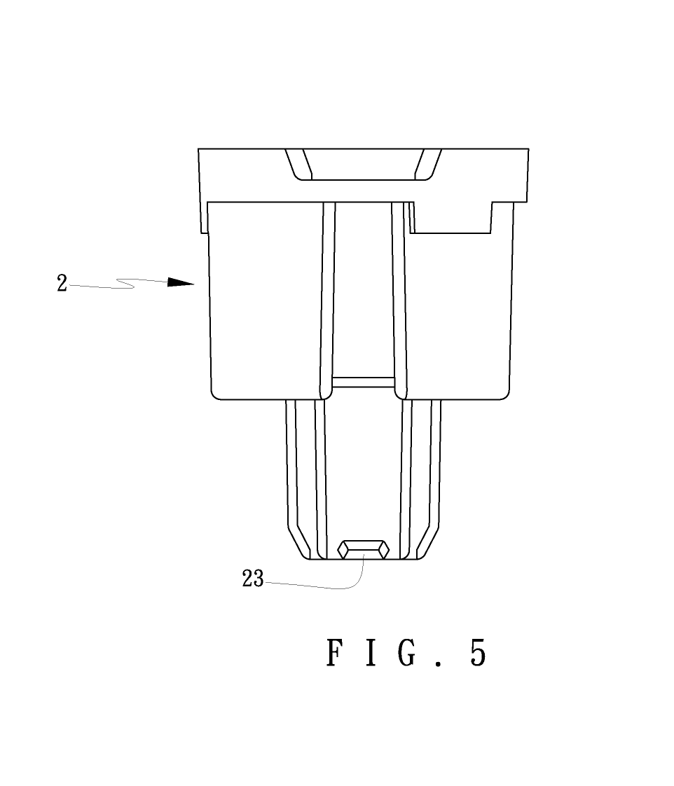

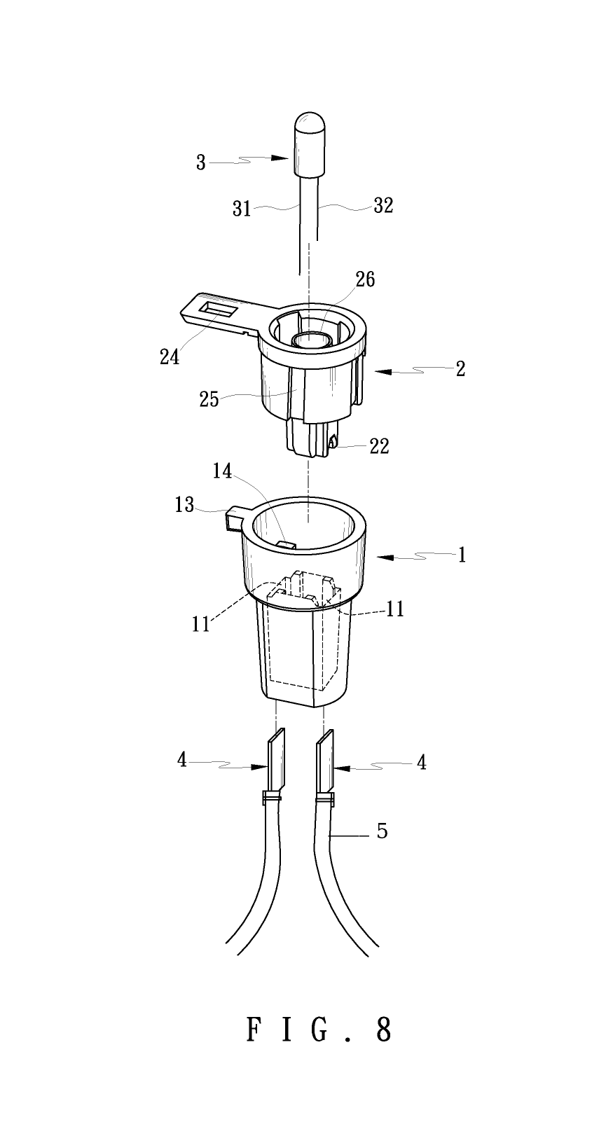

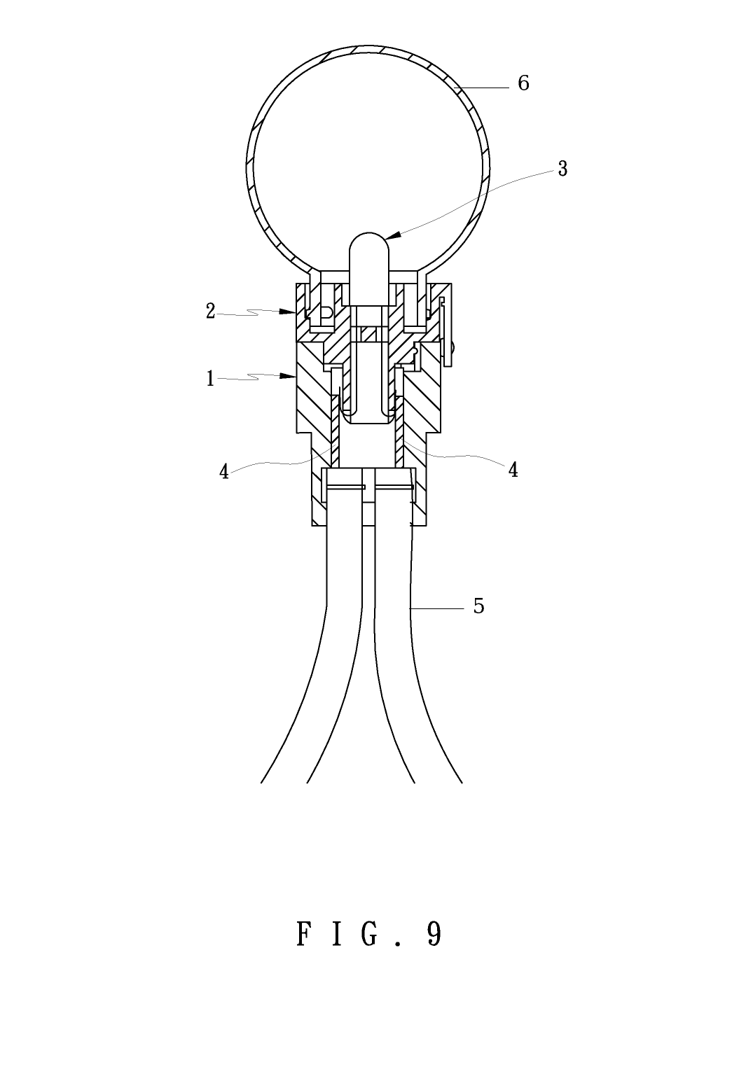

Referring to FIGS. 2 to 5, 8 and 9, an LED lamp in accordance with the invention comprises the following components as discussed in detail below.

A hollow socket 1 is formed of plastic and comprises a lower receptacle 11, a projection 14 formed on an inner surface of an upper portion, and a protrusion 13 extending outward from the top edge of the socket 1.

A hollow holder 2 is formed of plastic and is shaped to dispose in the upper and intermediate portions of the socket 1 as detailed below. The holder 2 comprises an axial channel 21, an annular flange 26 on one end of the channel 21, a first cut 22 on the downward projecting open bottom of the holder 2 distal the flange 26, a second cut 23 on the downward projecting open bottom of the holder 2 distal the flange 26, the second cut 23 being opposite the first cut 22 and larger than the first cut 22, a bendable holed handle 24 extending outward from the top edge of the holder 2, and a groove 25 formed on an outer surface of the holder 2, the groove 25 being complimentary to the projection 14.

In the assembled state of the holder 2 and the socket 1, the lower portion of the holder 2 is disposed in the upper and intermediate portions of the receptacle 11 and spaced from the walls of the receptacle 11, the groove 25 is snugly put on the projection 14, and an enlarged upper portion of the holder 2 is securely seated on the top edge of the socket 1 by bending the handle 24 downward about 90-degree to lockingly put on the protrusion 13.

Two opposite rectangular electrical contacts 4 are fastened on the walls of the receptacle 11 facing and spaced from the lower portion of the holder 2. Two conductive wires 5 each have one end secured to the electrical contact 4 and the other extending out of the bottom opening of the receptacle 11. An LED 3 is seated in the flange 26 and comprises a first contact wire 31 and a second contact wire 32 shorter than the first contact wire 31. The first and second contact wires 31, 32 are inserted through the flange 26 and the channel 21 to have their ends bent upward to pass through the first and second cuts 22, 23 to contact the electrical contacts 4 respectively. A bulb (e.g., glass bulb) 6 is provided to fasten on an upper portion of the holder 1 to enclose the LED 3.

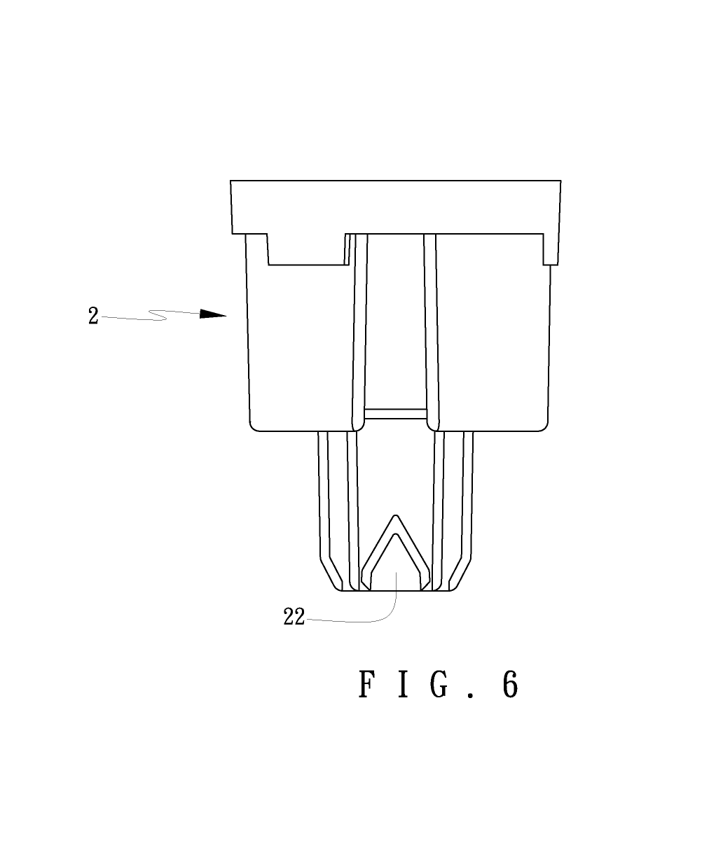

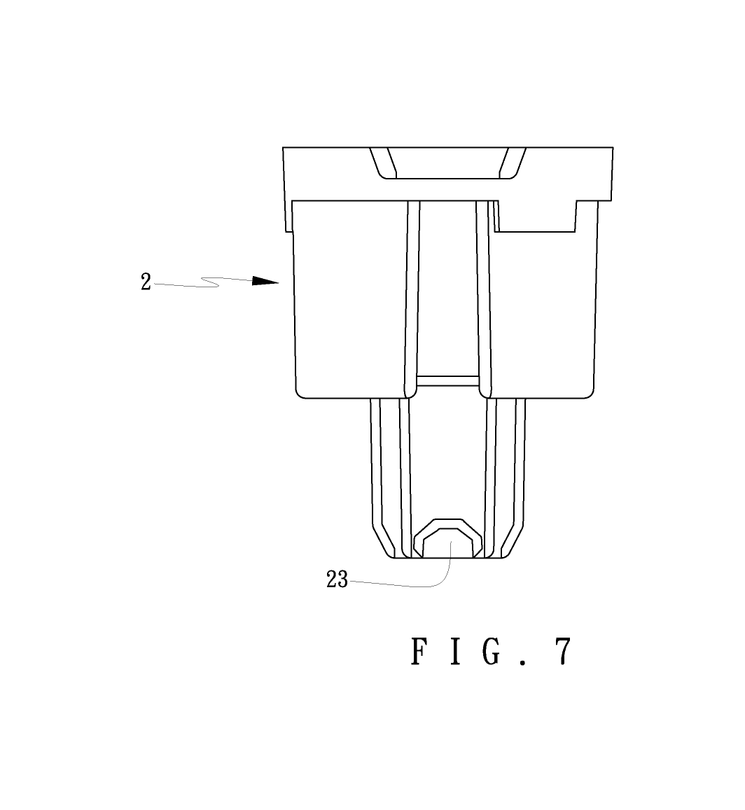

Referring to FIGS. 6 and 7, a second configuration of the holder 2 is shown. The first cut 22 is shaped as a gable and the second cut 23 is shaped as an “n”.

The LED lamp of the invention can be used as part of a light string for decorative or ornamental lighting (e.g., Christmas lighting) or a single light source.

While the invention has been described in terms of preferred embodiments, those skilled in the art will recognize that the invention can be practiced with modifications within the spirit and scope of the appended claims.

What is claimed is:

1. An LED light source comprising:
a hollow socket comprising a lower receptacle, a projection formed on an inner surface of an upper portion of the socket, and a protrusion extending outward from an upper portion of the socket;
a hollow holder comprising an axial channel, an annular flange on one end of the channel, a bottom first cut on the other end of the channel distal the flange, a bottom second cut on the other end of the channel opposite the first cut, a bendable holed handle extending outward from an upper portion of the holder, and a groove formed on an outer surface of the holder, the groove being complimentary to the projection wherein a lower portion of the holder is disposed in upper and intermediate portions of the receptacle and spaced from walls of the receptacle, the groove is snugly put on the projection, and the upper portion of the holder is securely seated on the socket by bending the handle downward about 90-degree to lockingly put on the protrusion;
two opposite electrical contacts fastened on walls of the receptacle and spaced from the holder;
two conductive wires each having one end secured to the electrical contact and the other extending out of the receptacle;
an LED seated in the flange and comprising a first contact wire and a second contact wire, the second contact wire being shorter than the first contact wire wherein both the first and second contact wires are inserted through the flange and the channel to have their ends bent passing through both the first and second cuts to contact the electrical contacts respectively; and
a bulb fastened on the holder to enclose the LED.
